(19) United States
(12) Patent Application Publication
(10) Pub. No.: US 2003/0198338 A1
(43) Pub. Date: Oct. 23, 2003

(54) Public telephone name server network

(76) Inventor: Li Kun Bai, Scarborough (CA)

Correspondence Address: DENNISON ASSOCIATES, 133 RICHMOND STREET WEST, SUITE 301, TORONTO, ON, M5H 2L7, CA

(21) Appl. No.: 10/394,186

(22) Filed: Mar. 24, 2003

(30) Foreign Application Priority Data
Apr. 22, 2002 (CA) 2,383,029

(51) Int. Cl. H04M 1/00; H04M 3/00

(52) U.S. Cl. 379/355.01

(57) ABSTRACT

A system and method for routing of telephone calls allows for convenient connection to a party where the telephone address is not known. A database is coded by keywords such as common nickname, trade-mark, or trade name. The system is available to all, and as such, becomes a valuable resource. Problems associated with telephone address recollection are avoided and the advertising message can concentrate on the corporate entity. In this way, contact information is more readily available and can be accessed in different manners using the telephone keypad to query the database.

### FIELD OF THE INVENTION

The present invention relates to a telephone system and in particular, relates to a telephone system which is more convenient to use.

### BACKGROUND OF THE INVENTION

The telephone system today works extremely well when the user knows the particular telephone number of a party that he wishes to speak to. Certain frequently used numbers are easily memorized, however, a problem occurs for less frequently used numbers. For example, important numbers such as your banker's number, your doctor's telephone number or the local Chinese take-out number must be confirmed by looking them up in a directory or other suitable means.

To partially overcome the problem, users have entered telephone numbers in small calendars or agendas that they carry with them or have entered them in electronic personal organizers. Even with these additional systems, people are often faced with the desire to place a call to a particular party but they are not sure of the telephone number. This problem is compounded by the growing popularity of cell phones which at least store some commonly used numbers.

Many companies spend considerable time, effort and resources in educating users of their corporate entity as well as various telephone numbers to allow the public to contact them. For many companies that provide home delivery, one of the most important factors in the buying decision is whether the person can remember the telephone number of the particular business. Many free products with a particular telephone number are provided to the homeowner such that when the need arises, the telephone number of the particular company will be readily available. This practice is used extensively in the real estate industry where calendars are provided to the public free of charge with the telephone number and particulars of the company provided on each page of the calendar. Fridge magnets and coupons are examples of the importance these companies place on having the telephone number readily available.

Other companies extensively advertise and often franchised businesses, such as Pizza Pizza advertise a common telephone number for a certain district and orders placed with this central group are distributed to the appropriate franchisee. Therefore from a corporate point of view, it is well recognized that the user must become educated with respect to their particular telephone number and hopefully have available to them when a buying decision is imminent.

From a user point of view, the recording of telephone numbers is a necessary step, however, it often goes uncompleted. If the recordal of the telephone number has been completed, it may not be readily available to the user at the time of the buying decision.

It is possible for the user to contact the local telephone company and for a certain fee obtain the telephone number of a desired party. This fee can often be a deterrent to completing the process in this manner.

There remains a need to provide a simple, effective solution to this problem.

There remains a need to provide a practical and convenient system for allowing completion of a telephone call to a party where good information with respect to the party's identity is known, however, the telephone number is not known or not known with confidence.

### SUMMARY OF THE INVENTION

A method for completing a telephone communication according to the present invention comprises

dialing the telephone number or signal of a telephone routing service provider having a database of telephone addresses coded by nicknames, trade-mark, web address, or trade name and a router for routing of the calling communication, entering a nickname, trade-mark, web address or trade name of a party to be communicated with,

the service provider identifying a telephone address using the entered nickname, trade-mark, web address or trade name; and

the service provider using said identified telephone address to route the calling party to the identified telephone address to complete the telephone communication.

According to an aspect of the invention, the service provider as part of the identification of the telephone address provides verbal identification of possible telephone addresses and the instructions for selecting one of the possible telephone addresses.

### BRIEF DESCRIPTION OF THE DRAWINGS

Preferred embodiments of the invention are shown in the drawings, wherein:

FIG. 1 is a schematic overview showing the use of the telephone routing system in a centralized method;

FIG. 2 is a schematic overview showing completion of a call using the call routing system in a distributed method;

FIG. 3 is a schematic overview showing completion of a call using the call routing system in a centralized router system; and

FIG. 4 is a schematic of an alternate centralized router system network.

### DETAILED DESCRIPTION OF THE PREFERRED EMBODIMENTS

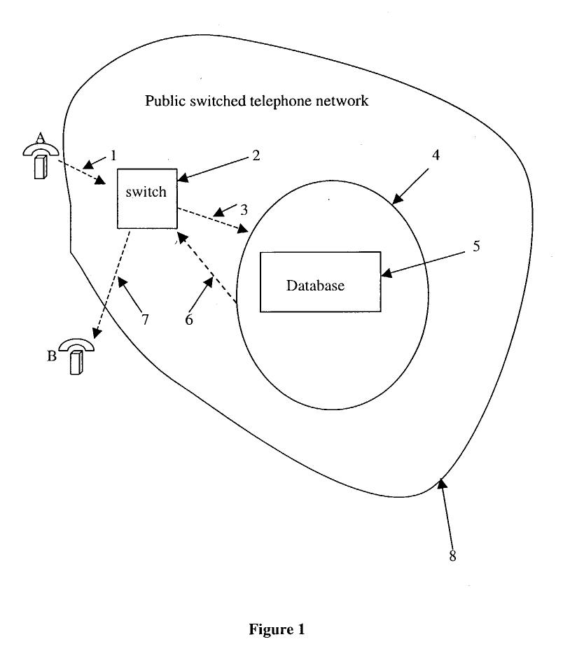

A public centralized telephone router system 4 shown in FIG. 1 is designed to store a host of different telephone numbers where a user can access these telephone numbers in a non-conventional manner. The router system has a common telephone number for initiating contact therewith and thus the user must remember a single number for seeking clarification of telephone numbers of interest to him. Various businesses will pay to have their number made available on this system and these numbers can be broken into a number of different categories and subcategories.

A fundamental principle according to the present invention is that telephone numbers will be accessible by using key words or numbers, or symbols that are known to the user. For example, if the user wishes to contact VISA, he can call the telephone number of the routing system and punch in VISA using the keypad on the telephone. This is a very large company and the number of calls to this group could be quite large. Therefore, this group is assigned a simple code which is basically their corporate name. The user is then provided feedback with respect to the code that he has entered and/or options associated with that particular code. The user might well hear VISA, followed by “if this is acceptable, press the # sign”. The completion of this sequence will redirect the call to VISA.

The router will contact the associated public telephone switch and instruct the switch to redirect the particular call to a determined phone number provided to the switch. The router system is no longer involved in the communication and is ready for further calls.

With this system, different corporate entities will pay to have their numbers listed on the central service and the entry of their corporate name or common nickname will provide the user with the opportunity to accept this connection. From a user's point of view, this is extremely convenient. If the user is in doubt with respect to a telephone number, he merely calls the common number of the telephone routing service and enters the appropriate nickname for the party that he wishes to reach.

The calling party may use this service to purchase goods or services. For example, a tourist in a city may wish to order in pizza. In this case, he can call the routing system and enter the code using the keypad on the telephone which corresponds to the word PIZZA. The entry of this code would result in a response from the routing system as “for PIZZA PIZZA, enter 1”, “for PIZZA HUT, enter 2”, “for PIZZA NOVA, enter 3”, etc.

Another example may require the user to try to locate his doctor. In this case, the user would telephone the central routing service and enter the area code of the doctor followed by the word doctor. He would then be prompted to further clarify the identity of the particular doctor by spelling his last name. The system can then respond with a list of doctors and their addresses and the user can select the correct listing.

One of the prime benefits of the centralized routing system is that the call routing system merely facilitates the connection of the user with a desired telephone number. The system does not form part of the ongoing connection and thus the telephone lines that are available to it are not in use during the actual call. These lines are only in use in determining the telephone number of interest to the calling party. Once this step has been completed, the call is forwarded and the routing system is no longer involved.

This type of routing system is sometimes referred to as a Voice Process System which can automatically transfer telephone calls without continuing to be part of the communication path. The system sends a signal to the telephone switch to redirect the call to a particular number. This frees the system to handle more calls. One such system is sold by Applied Voice Technology under the trade-mark PhoneXpress.

FIG. 1 shows a local area public switched telephone network 8 with a public centralized router 4. Initial party A, dials the telephone number of the service provider and makes connection 1 and 3 through public switched telephone switch 2. The router 4 receives the phone name from party A and searches the phone name index database 5. The router sends a redirecting signal and real number 6 to the switch to build connection 7 and redirect the call to destined party B.

With the public centralized telephone server or router, the database of telephone numbers can be associated with distinctive meaningful names which are more easily remembered by customers and users. There is no longer the requirement for a corporate entity to advertise their corporate or nickname as well as a specialized telephone number. They can merely promote connection thereto via the common number associated with this service provider. A specialized number for the service provider can be used such as 1-800-444-4444, or 1-200.

Customers now have an effective process which is easily completed to contact a desired business or provider of a service or a product. This is in direct contrast to the conventional situation where a telephone number is assigned to a business, without any meaningful or easily understood manner of remembering the same.

The prior practice of selecting a number which is more easily remembered was a step in the right direction, however, this quickly becomes ineffective and meaningless when a host of different specialized numbers are now used. Thus, in the existing systems the company's telephone number must be remembered and there is no connection between the company name and the telephone number.

The public centralized router system allows companies to link their corporate name, web address or business activities with a telephone number in a transparent manner to the calling party. For example, in an attempt to reach a local number for the SONY company in Toronto, the user merely calls the known number of the server and enters the nickname SONY. A series of options or an automatic forwarding to the proprietary SONY telephone system will allow effective processing of the call.

The present system can also use known web addresses to complete a telephone connection with a desired party. The user contacts the phone name server in the manner previously described and enters a domain name category. This can be accomplished by dialing a special number or through a selection process. The caller then enters the domain name. For example, a caller can contact the phone name server and select a web name division, preferably divided by category such as com, org, ca, etc. Once the category is determined, the user can enter the domain name such as nytimes for the New York Times. The phone name server then uses the entered domain name to determine the desired phone number and connect the user with the New York Times. In this way, known web addresses are used to complete both INTERNET communications and telephone communications.

The phone name server application has additional benefits in that the subscriber is promoting his contact identity as opposed to a particular telephone number. In this way, callers are not directly using the telephone number as this is used by the phone name server. With this arrangement, the subscribing party can change his telephone number service provider, his cell phone number, etc., without interruption or inconvenience to calling parties using the phone name server. The subscriber can change his cell phone number, or phone service, and merely advise the phone name server of the new contact information. This arrangement avoids the situation of having to advise all contacts of a change in telephone number address. Furthermore, this system, provides companies with the ability to expand for additional personnel, and the company is not tied to a particular cell phone or telephone provider. Changes in telephone providers can be made without interruption in service and without callers requiring new contact information.

Part of this service can include establishing a separate database with respect to a white page directory. Basically, the calling party can enter the last name and first name of the party he wishes to reach and the system provides a series of possible matches for consideration. This additional information can be provided in an audible signal, such as the person's name and address. The calling party can indicate the proper match from the list of possible matches.

In some cases, it may be desirable to offer a new telephone device with its own dedicated key to allow completion of a call to the router. Similarly, a specialized number can be provided for cell connection to the server.

As can be appreciated, the server can include a series of vocal instructions or options back to the calling party to overcome issues associated with the limitation of the keypad of the telephone set. For example, the common keypad has the letters A, B, and C associated with the keypad for the number 2. The server can provide the information regarding choices regarding these designations to allow better matches or reduced number of matches from the electronic directory. Many cell phone and traditional phones include a display screen and the telephone has different modes for distinguishing between the numeric keypad and the complete numeric/alphabetic keypad. In this numeric/alphabetic mode, multiple pressing of a key steps through the possible key designations which are then shown on the screen. In this way, full identification of web addresses, products or names is realized.

For example, once the user enters the name according to the keypad, the server can respond with questions such as “press 1 for names which start with the letter “A”, “press 2 for names that start with the letter “B”, “press 3 for names that start with the letter “C”. In this way, the call can then be routed to a subrouter for all of the listings for A, B, or C. This one piece of additional information will significantly reduce the number of potential matches possible and thus expedite the processing of the information.

Because the link between the digits to letters on the telephone pad, there may be a duplication, for example, the enter sony, the digits are the same as romy, in this case the routing system can give vocal choice, like for Sony enter 1, for romy enter 2. As previously described, many phones now have a full keypad mode for using the numeric/alphabetic keypad of the phone and displaying the result on a small display screen. This capability allows the user to enter full information.

There are other approaches for processing calls and the present invention is not limited to the preferred embodiment described. Any logical code or easily remembered code can be used and different combinations can be used.

For example, names, trade-marks, nicknames, partial names of companies, firms or individuals can be used. The system can also operate using subject matter, industry name or product group such as bank, credit, pizza, etc. A further category can be based on occupations such as doctor, buyer, accountant, contractor, etc. Other examples include ★★★★ for 4 Star hotels, and “crime tips” for public information, etc.

With the present system, various codes or nicknames can be associated with a particular telephone address. This provides a higher possibility of a good match.

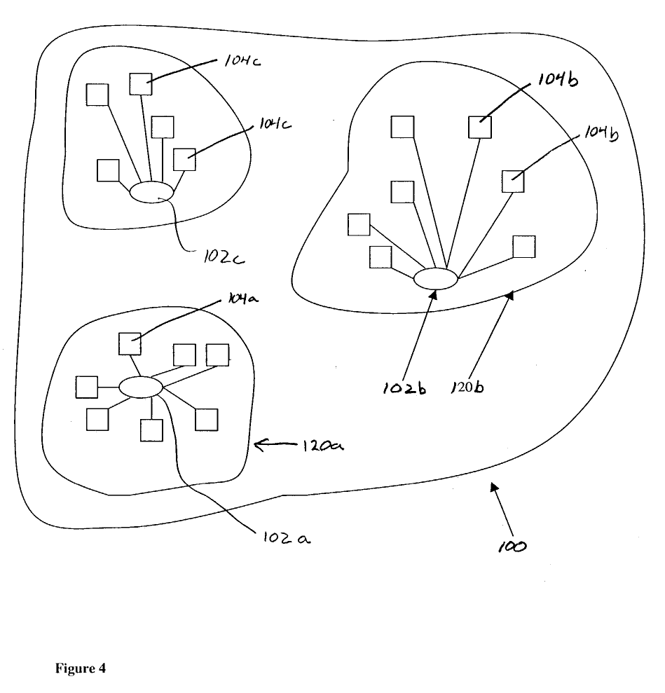

Another way to implement the routing system is shown in FIG. 4 using a tandem structure with the centralized server.

In a local area network 100, several phone name servers 102a, 102b and 102c are used which are preferably accessed by a common special number such as 311 or #. Each time any of the switches 104 receives a 311 communication, the switch routes the call to the associated or designated phone server 102. Several phone name servers 102 are provided in the local area network 100 and each phone name server is associated with certain designated switches. With this arrangement, as additional capacity is required, a new phone server can be added and certain designated switches reassigned. It is also possible to reassign switches to even demand between phone name servers.

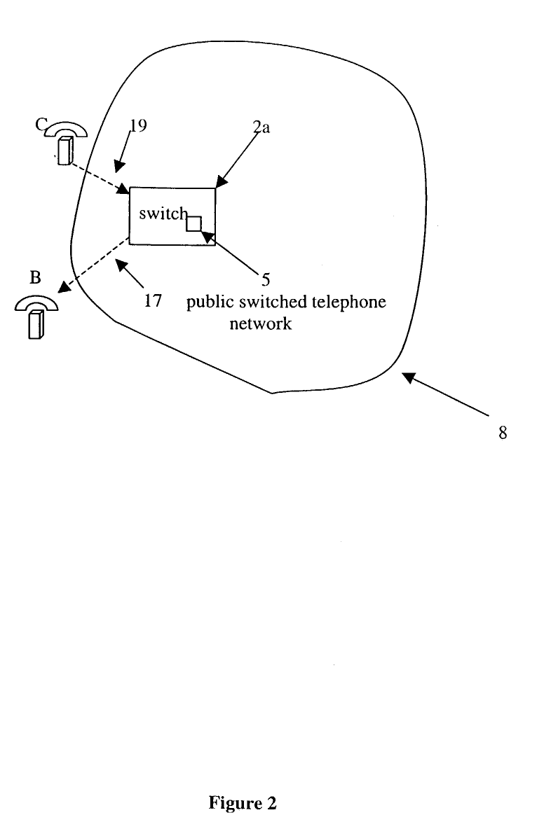

In FIG. 2, the initial party C is connected to switch 2a through the connection indicated as 19. Switch 2a has the database 5 associated therewith and can provide a match quickly. The match allows switch 2a to complete the communication to party B through the connection indicated as 17.

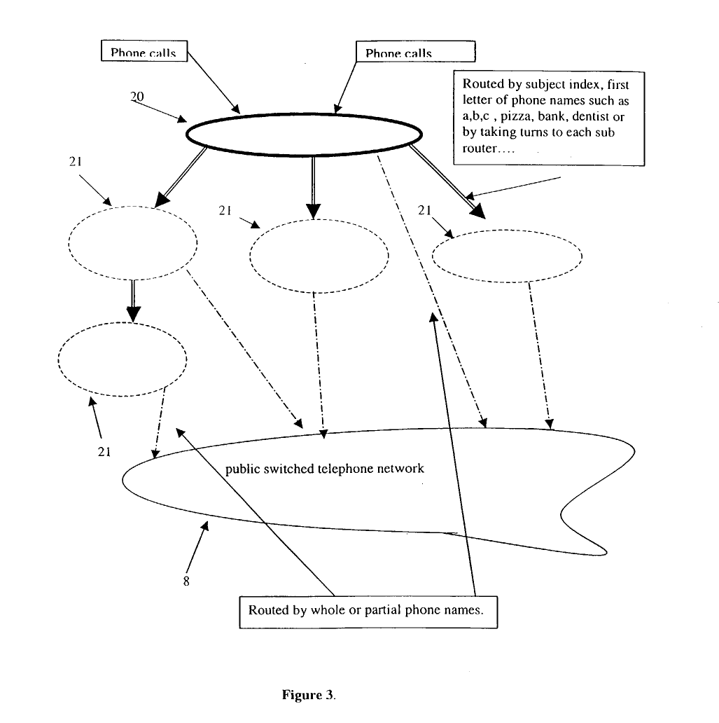

FIG. 3 shows a centralized routing system where distributing calls are initially provided to a main router 20. The main router 20 has associated therewith, a number of subrouters 21. The main router 20 routes to the subrouters 11 perhaps by subject, index or first letter of the telephone names, which is A, B, C, or by codes, such as PIZZA, BANK, DENTIST, CREDIT CARD, or other terms. Basically, the call originating with calling party A is provided to the main router 20 and then handed off to the subrouter 21. The subrouter 21 as it is now a specialized subrouter, can handle the call more efficiently to provide effective transfer to the end party. One of the key considerations in the present system is the ability for the fast connection of the calling party to the destined party. This process is carried out by nickname, corporate names or other non-telephone number type information that is entered by the originating party. The use of the subrouters based on initial information provided by the user expedites the process and as shown in FIG. 3, further subrouters can be used.

In FIG. 4, a phone name server 102a is responsible for routing calls in region 120a containing a series of switches 104a. Similarly, region 120b has associated switches 104b and region 120c has associated switches 104c.

All switches of a region route communications to the designated phone name server which then redirects the communication as previously described. Expansion of this system is easily implemented by merely reassigning switches to an additional phone server. The step of assigning the switches to a given phone server allows effective distribution of communications by the phone server provider. Traffic can be monitored and expansion or adjustment of the system can be implemented by the provider in an effective manner. With this arrangement, a common number is used by the calling parties to reach a phone server for processing. The switches function in a conventional manner and existing switches do not require additional functionality.

The regional system of FIG. 4 is preferable for redirecting of calls to a cell phone number. The calling party merely uses the “phone name” address which the subscriber has instructed the server to direct the communication to a cell phone number. If the subscriber decides to change call phone providers, the new call phone number is provided to the phone name servers. This change in cell phone providers is transparent to any parties which use the known “phone name”.

The present phone name server system allows the user to direct communications in a desired manner. For example, the phone name server can maintain a series of telephone numbers which can be used for completing a communication. For example, a user can provide an office telephone number, a cell phone number and a message number. The user can instruct the phone name server to use one of these telephone numbers or can provide instructions when each number is to be used. For example, a time schedule could allow the phone server to change from one phone number to another.

Each server can also include a tracking arrangement based on communication received by the phone name server from different associated switches. This information can be used to reassign switches to different phone name servers and/or provide information for assessing the need to introduce a further phone name server for a particular region.

The routing system is integrated into the public switch telephone network. The switches of the telephone network recognize special signal and knows a phone name follows. The phone name is provided to the database which uses this information to identify the real number and then build the connection. For example, a directly linking telephone sends a special signal ‘#’ followed by Sony, the switch connects the calling party to the local Sony store. This switch can only route its direct linked telephone calls.

If all the switches in a local area are integrated with the routing system, then in this local area all phones can use the phone name to make phone calls. The advantage of the distributed routing system is it can handle a huge call volume and avoid a central bottleneck. This method requires the phone network to maintain duplicated database.

Although various preferred embodiments of the present invention have been described herein in detail, it will be appreciated by those skilled in the art, that variations may be made thereto without departing from the spirit of the invention or the scope of the appended claims.

The embodiments of the invention in which an exclusive property or privilege is claimed are defined as follows:

1. A method for completing a telephone communication comprising dialing the telephone number of a telephone routing service provider having a database of telephone addresses coded by nicknames, trade-mark or trade name and a router for routing of the calling communication, entering a nickname, trade-mark or trade name of a party to be communicated with,
said service provider identifying a telephone address using the entered nickname, trade-mark or trade name; and
said service provider using said identified telephone address to route the calling party to the identified telephone address to complete the telephone communication.

2. A method as claimed in claim 1 wherein said service provider as part of the identification of the telephone address provides verbal identification of possible telephone addresses and the instructions for selecting one of the possible telephone addresses.

3. A method as claimed in claim 1 wherein the database is also coded by product and service.

4. A method as claimed in claim 3 including using caller I.D. information to limit the search criteria.

5. A method as claimed in claim 3 including a series of routers for distributing calls.

6. A method as claimed in claim 1 wherein said service provider is a series of phone name servers where each phone name server is associated with a series of telephone switches and said associated switches direct any received telephone communications which use said telephone number of said telephone routing service provider to said associated phone name server.

7. A system for completing telephone communications directed to an end party identified by a phone name which is not a telephone number comprising a series of phone name servers were each phone name servers is associated with a series of telephone switches of a telephone system, each phone name server receiving telephone communications originating by dialing a telephone number, each server upon receiving a telephone communication requiring the originating party to enter a phone name, address of a party to be communicated with and using said phone name to search a database of said phone name to search a database of said phone name server and identifying a telephone address associated with said phone name, said server, then communicating with said associated switch causing said switch to route the calling communication to the identified telephone address associated with the particular phone name.

8. A system as claimed in claim 7 wherein each phone name server includes a similar database of phone names.

9. A system as claimed in claim 8 wherein each phone name server includes a tracking arrangement for determining demand based on number of communications directed to said server from each switch and using the results of said tracking arrangement to reassign switches to different servers or new servers.
